(19) United States
(12) Patent Application Publication
(10) Pub. No.: US 2020/0338791 A1
(43) Pub. Date: Oct. 29, 2020

(54) A METHOD FOR PRODUCING A REINFORCEMENT SECTION IN A WORKPIECE

(71) Applicant: HOMAG Bohrsysteme GmbH, Herzebrock-Clarholz (DE)

(72) Inventors: Thomas BETTERMANN, Bielefeld (DE); Boris THIESSEN, Rheda-Wiedenbrück (DE)

(21) Appl. No.: 16/764,839

(22) PCT Filed: Nov. 14, 2018
(86) PCT No.: PCT/EP2018/081199

§ 371 Date: May 15, 2020

(30) Foreign Application Priority Data
Nov. 17, 2017 (DE) 10 2017 127 097.3

(51) Int. Cl. B29C 39/10; B32B 3/12; B32B 5/18; B32B 21/04; B32B 21/02; B32B 21/06; B32B 3/08; B29C 39/24

(52) U.S. Cl. CPC B29C 39/10; B32B 3/12; B32B 5/18; B32B 21/047; B32B 21/02; B32B 21/06; B29K 2101/10; B29C 39/24; B32B 2479/00; B32B 2266/0228; B32B 2305/022; B32B 2305/024; B32B 2305/08; B32B 3/08

(57) ABSTRACT

The invention relates to a method for producing a reinforcement section in a preferably plate-shaped workpiece, wherein the workpiece has a core layer, a first cover layer and a second cover layer. In particular, such a workpiece may be a lightweight building board. Provision is made therein for a pasty, thermosetting mass to be introduced into an opening by way of the nozzle, while the nozzle and/or the workpiece moves at least temporarily during the release of the mass.

### TECHNICAL FIELD

The present invention relates to a method for producing a reinforcement section in a preferably plate-shaped workpiece, wherein the workpiece has a core layer, a first cover layer and a second cover layer. In particular, such a workpiece may be a lightweight building board. Lightweight building boards are used in the furniture or components industry, for example. In particular, the workpiece may be a door leaf, a furniture front piece, a wall unit or the like.

### PRIOR ART

A method for forming an engagement portion in a workpiece is known from DE 10 2015 212 852 A1. There, a workpiece is provided with a recess, into which a predetermined volume of a curable filling compound is introduced. Moreover, an engagement element is introduced into the curable filling compound, wherein the engagement element has an engagement structure which constitutes at least in part a geometric counterpart to the engagement section, the engagement element occupies a predetermined position of the workpiece, and the engagement structure is arranged at least in part in the filling compound.

Although it is possible using this method to easily form an engagement section in the workpiece which constitutes a negative of the engagement structure of the engagement element, it has been shown that introducing such a region into a workpiece having a core layer has increased requirements.

### SUBJECT MATTER OF THE INVENTION

An object of the present invention is to provide a method for forming a reinforcement section in a workpiece having a core layer, such that the reinforcement section provides as high a pull-out resistance as possible, for example, and therefore also increased holding power.

The subject matter of claim 1 provides a corresponding method. Furthermore, the invention relates to a furniture element or a lightweight building board comprising at least one reinforcement section. Further preferred embodiments of the method and of the furniture element/lightweight building board are described in the dependent claims, wherein the subject matters of each of the dependent claims can be combined with any of the independent claims.

The present invention has the advantage that a reinforcement section can be introduced into a workpiece having a core layer by way of the method steps according to the claim. If the reinforcement section is used as a fastening section, it can facilitate the attachment of a fastening element such as a screw, a pin or the like.

In this regard it has been shown that by moving the nozzle relative to the workpiece it is possible to produce a layered structure of the thermosetting mass, at least in part, such that the thermosetting mass penetrates the core layer of the workpiece to a reduced extent.

In order to achieve a form fit between the hardened mass and the workpiece, penetration into the core layer may still be desired. However, the layer-by-layer application of the thermosetting mass in workpieces having an open core layer can result in the thermosetting mass only penetrating the core layer to a limited extent on account of the process that is similar to that of 3D printing.

It has proved advantageous particularly in the case of workpieces having a foam core layer to slowly move the nozzle tip from the lower cover layer upwards. As a result, a uniform plug can be created in the plate.

Furthermore, it is also possible to form the thermosetting mass from the first cover layer to the second cover layer and therefore to secure the reinforcement section in the workpiece to a certain extent.

The invention provides a method for producing a reinforcement section in a workpiece, wherein the workpiece has a core layer, a first cover layer and a second cover layer and the method comprises the steps of: creating an opening in the workpiece, wherein the opening extends through the first cover layer and into the core layer, moving a nozzle to the opening in a first direction, releasing a pasty, thermosetting mass into the opening by way of the nozzle, while the nozzle and/or the workpiece moves at least temporarily during the release of the mass.

According to one embodiment, provision is made for the core layer to have a honeycomb structure, a foam material, in particular a plastic foam such as polystyrene rigid foam, wood foam, metal foam such as aluminium foam, paper, cardboard or one or more timber struts.

It is preferred that the nozzle is moved/guided in a translational and/or rotational movement during the release of the mass. In this way it is possible to discharge the pasty mass in layers.

According to one embodiment, provision is made for a mould element to be introduced into the pasty mass prior to the hardening thereof, so as to form a thread or an opening following the removal of the mould element. Thus, a thread or a blind bore, for example, can be created in the mass relatively easily.

It is preferred that the pasty mass is fed to the nozzle by way of an extruder or a pump system.

A further embodiment provides for the opening being made through the core layer and partially into the second cover layer. Thus, the mass to be introduced into the opening can be anchored to the second cover layer following the hardening thereof.

Moreover, provision can also be made for the nozzle to be introduced into the opening before the pasty mass is released by the nozzle. This course of action makes it easier to avoid trapped air in the pasty mass. Furthermore, a particularly even filling of the mass in the opening is ensured.

According to a further variant, it is possible that the volume of the pasty mass that is introduced into the opening by way of the nozzle is greater than the volume defined by the opening. The proportion of the pasty mass penetrating the core layer is taken into consideration and, moreover, the opening is completely filled with the pasty mass.

According to one embodiment, provision is made for the pasty mass to be a thermoplastic mass which becomes thermoplastic when heated and which hardens when it cools. Within the scope of this embodiment the pasty mass is applied in a heated state. Cooling and therefore hardening takes place in the opening.

Alternatively, it is possible to use a UV-curing mass which is activated by radiation with UV light. This alternative is characterised by a relatively high curing speed.

Following the hardening of the pasty mass, a form-fitting connection with the workpiece can be formed. The form fit can be achieved between the first and second cover layers. Thus, the hardened mass is firmly anchored in the workpiece and the maximum pull-out force is increased.

The thermosetting mass can be introduced into a side region of the opening. According to this variant, the mass can provide a seal for the exposed core layer, such that the core layer is protected from moisture.

According to a further embodiment, provision is made for the opening to be made in the workpiece in a linear manner, when viewed from above, wherein it is preferred that the opening is filled with the thermosetting mass.

It is particularly preferred that the linear opening surrounds a workpiece region which is removed following the hardening of the thermosetting mass in the opening. The opening may, for example, be designed so as to be circular when viewed from above.

According to a further embodiment, provision is made for the pasty mass to be introduced into the opening in such a way that the reinforced region can serve as a sliding bearing. In particular, it is possible to form a plastic sliding bearing. Since the sliding bearing is formed directly in the workpiece, special shapes or specifically requested dimensions can be realised. For instance, it is possible to form a sliding bearing having a triangular or rectangular cross section, wherein the sliding movement constitutes an axial movement.

Provision can also be made for the mass introduced into the opening following the hardening thereof to be partially removed, in order to form as smooth a surface as possible. Alternatively, it is possible to press a cylindrical body, for example, into the not yet hardened mass and to remove it again following the hardening thereof.

As a further embodiment, an existing sliding bearing can be pressed into the not yet hardened mass, wherein the sliding bearing introduced in this way is anchored into the mass following the hardening thereof.

According to a further embodiment, the method is carried out in a machining device, in particular a machining device for machining plate-shaped workpieces. It is preferred that the workpiece is held in a single clamping operation. In this way, the formation of the opening and the introduction of the mass can be carried out in a precise manner.

Furthermore, the invention relates to a lightweight building board or a furniture element such as a kitchen worktop, a wall unit, a removable shelf or the like. Provision is made for the furniture element to have a first cover layer and a second cover layer, wherein a reinforcement section is introduced in layers through one of the cover layers and into the core layer lying between the cover layers. It is preferred that the reinforcement section is formed according to one of the aforementioned embodiments.

With the reinforcement section a fastening section, for example, can be formed, to which a connecting element can be attached for connecting the furniture element to another furniture element or similar. Alternatively, provision is made for the reinforcement section to form a sliding bearing. In the sliding bearing a rotational or translational sliding movement can be performed by a bearing element.

### BRIEF DESCRIPTION OF THE DRAWINGS

FIG. 1 shows a schematic representation of a first embodiment of the invention.

FIG. 2 shows a schematic representation of a second embodiment of the invention.

FIG. 3 shows a third embodiment of a method according to the invention.

### DETAILED DESCRIPTION OF THE PREFERRED EMBODIMENTS

In the following, the invention will be described in more detail on the basis of a plurality of embodiments and with the help of the enclosed drawings. Modifications described within the scope of the embodiments can be combined in order to form further embodiments of the invention.

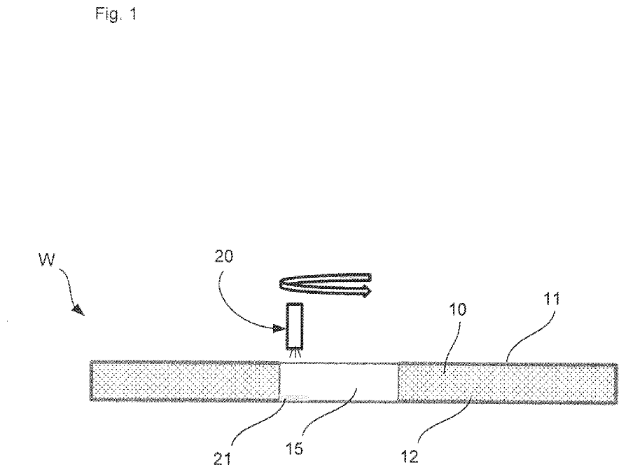

FIG. 1 shows a schematic view of a workpiece W. The workpiece has a core layer 10, a first cover layer 11 and a second cover layer 12. In particular, the workpiece W is a lightweight building board, wherein the core layer 10 has a lower density than the material of the first and/or second cover layers 11, 12. In particular, the core layer 10 is made of a foam material, such as a polystyrene rigid foam, while the cover layers are made of a plywood material.

In the representation according to FIG. 1, a bore (opening) 15 formed as a blind bore has already been made in the workpiece W. The bore 15 is made using a milling head or a drilling head, for example, such that the first cover layer 11 and the core layer 10 are penetrated. Moreover, in the embodiment example the drilling head or milling tool also enters the second cover layer 12, but does not penetrate it.

Subsequently, a nozzle 20 is introduced to the workpiece W. This nozzle 20 is connected to an extruder (not shown) that conveys a pasty, thermosetting mass to the nozzle 20. The nozzle 20 is provided with one or more openings for discharging the pasty, thermosetting mass 21.

In the present embodiment example, the pasty mass is an extruded thermoplastic material which is discharged from the nozzle 20 at an injection temperature of approximately 220° C.

The thermoplastic material is introduced into the bore (opening) 15 to form a reinforcement section, while the nozzle 20 and the workpiece W are moved relative to one another. In particular, the workpiece W is kept stationary while the nozzle is guided in a translational or rotational movement relative to the workpiece W.

In the embodiment shown in FIG. 1, the nozzle 20 is guided in a circular movement in a plane parallel to the surface of the workpiece W formed by the first cover layer 11. During this movement of the nozzle 20, the thermoplastic material is continuously discharged and therefore the bore (opening) 15 is gradually filled with the thermoplastic material in the side region or in its entirety.

Since in the present case the core layer 10 is a polystyrene rigid foam, the thermoplastic mass introduced fuses in part to the core layer 10 such that the thermoplastic mass displaces the core layer or penetrates into it. However, since the nozzle 20 moves relative to the workpiece W, the thermoplastic mass is prevented from penetrating too far into the core layer. Instead, the bore 15 is filled by the application of the pasty mass in layers.

Since the bore 15 has been made in the workpiece W in such a way that the bore 15 extends into the second cover layer 12, the pasty mass provides an anchoring between the first and second cover layers 11, 12.

Once the pasty, thermosetting mass 21 has been introduced into the bore 15, the mass can harden according to a first variant. Subsequently, an opening is made in the hardened mass using a drill. Alternatively, according to a further variant it is possible to introduce a thread into the hardened mass. In this way, a contact point for a screw or similar can be created.

According to a modification it is possible to introduce or press into the still pasty mass an engagement element, such as a screw, such that the screw serves as a negative mould, wherein a thread remains in the reinforcement section once the pasty mass has hardened and the screw has been unscrewed.

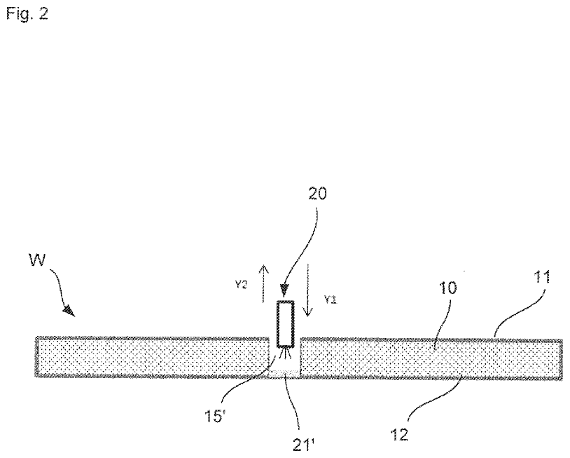

FIG. 2 shows a second embodiment of the invention. The second embodiment essentially differs from the first embodiment in that the opening 15′ has a smaller diameter than the opening 15 of the first embodiment.

The nozzle 20, which has already been described with respect to the first embodiment, is used to introduce the pasty, thermosetting mass 21. However, according to the second embodiment, the nozzle 20 moves in a translational direction during the introduction of the pasty, thermosetting mass.

In particular, the nozzle 20 is first of all brought into the region of the workpiece W in such a way that the nozzle 20 extends at least in part into the opening 15′ (movement in direction Y1). Then, the introduction of the pasty mass 21 begins, and during the introduction of the pasty mass 21 the nozzle 20 continuously or gradually moves out of the opening 15′ and away from the workpiece W (direction of movement Y2). In this way, the pasty mass is introduced into the opening 15′ in layers.

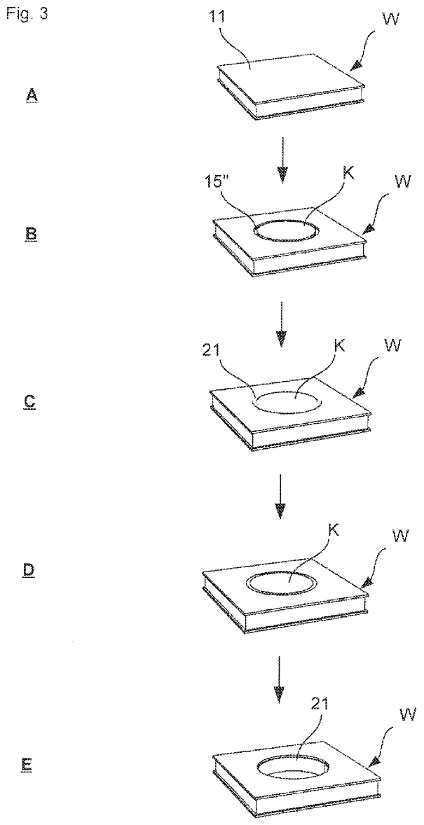

FIG. 3 shows a third embodiment of the method according to the invention within the scope of a plurality of successive machining steps. A workpiece W is machined in the same way as or in a similar manner to the embodiments described above. With regard to the details of the workpiece W, reference is made to the statements made above.

Once the workpiece W has been provided in machining step A, an opening 15″ which is circular when viewed from above is made in the workpiece W in a subsequent machining step B. When viewed from above, the circular opening 15″ surrounds a workpiece region K. As in the embodiments described above, the opening 15″ is formed as a blind bore and therefore does not penetrate the lower cover layer of the workpiece W.

In a further machining step C, the pasty mass 21 is now introduced into the opening 15″ by way of the nozzle (not shown) and the opening 15″ is completely filled with the pasty, thermosetting mass 21. Moreover, the thermosetting mass 21 protrudes over the upper cover layer of the workpiece W, such that a complete filling of the opening 15″ is ensured.

Subsequently, the mass 21 protruding over the opening 15″ which at this point has already hardened is removed (machining step D in FIG. 3). For this, a milling tool, for example, is used, as one possible finishing step, wherein the milling tool is guided along the contour of the opening 15″. In this connection it is preferred that the milling tool is used that is also used for making the opening 15″. In this way, the milling tool can be guided along the same path that was also used to make the opening 15″. Since the milling tool therefore has a diameter corresponding to the width of the opening 15″, it is possible to remove the protruding hardened mass in such a way that it is flush with the upper cover layer.

As an alternative to the aforementioned machining step using a milling tool or similar to finish the hardened mass, provision can be made for the not yet completely hardened mass to have pressure applied to it by an object such as a plate or a roll, such that the upper side of the mass is flush with the upper side of the workpiece. As a result of the pressure exerted, the mass will be pushed further into the core layer. In this way, the surface of the mass is flattened, such that a surface of high quality is provided.

This process is performed once a final layer has been applied that partially protrudes over the upper side of the workpiece. If a roll is used, for example, it is guided over the filled opening.

If the object used is a metal plate or a metal role, it is possible to dissipate the heat from the not yet completely hardened pasty mass by way of the thermally conductive material.

In a further machining step E, the internal workpiece region K is now removed, wherein a milling tool can also be used for this. During this machining step, the milling tool used here may come into contact with a side portion of the hardened mass 21, such that it is ensured that the core layer is completely removed within the contour defined by the hardened mass 21.

Within the scope of method step E provision can be made for the lower cover layer of the workpiece W to remain in place. Alternatively, it is also possible to remove the lower cover layer within the scope of method step E.

It is therefore possible using the method shown in FIG. 3 to provide the core layer of the workpiece W with a side seal, such that the core layer is protected from its surroundings in spite of the opening that has been formed. In this way, the ingress of moisture into the core layer can be prevented, for example. Furthermore, one or more attachment points can be provided on the hardened mass.

According to a further embodiment that is not shown, provision is made for a bearing material to be introduced into the opening, with the help of which pieces of furniture can easily slide on individual profiles, for example. In particular, this is a plastic sliding bearing. Folding furniture, the component parts of which can slide on a rail or a bearing, is advantageous particularly in the lightweight sector. A bearing introduced in this way can be made in special sizes and can be custom-made. As an example, such a bearing may be a guide in a sliding door.

1. A method for producing a reinforcement section in a workpiece, wherein the workpiece has a core layer, a first cover layer and a second cover layer the method comprises the steps of:
creating an opening in the workpiece, wherein the opening extends through the first cover layer and into the core layer, moving a nozzle to the opening, and
releasing a pasty, thermosetting mass into the opening by way of the nozzle, while the nozzle and/or the workpiece moves at least temporarily during the release of the mass.

2. The method according to claim 1, wherein the core layer has a honeycomb structure, of foam material, wherein the foam material can be a plastic foam such as polystyrene rigid foam, wood foam, metal foam such as aluminium foam, paper, cardboard or one or more timber struts.

3. The method according to claim 1, wherein the nozzle is guided in a translational and/or rotational movement during the release of the mass.

4. The method according to claim 1, wherein a mould element is introduced into the pasty mass prior to the hardening thereof, so as to form a thread or an opening following the removal of the mould element.

5. The method according to claim 1, wherein the pasty mass is fed to the nozzle by way of an extruder or a pump system.

6. The method according to claim 1, wherein the opening is made through the core layer and partially into the second cover layer.

7. The method according to claim 1, wherein the nozzle is introduced into the opening before the pasty mass is released by way of the nozzle.

8. The method according to claim 1, wherein the volume of the pasty mass that is introduced into the opening by way of the nozzle is greater than the volume defined by the opening.

9. The method according to claim 1, wherein the pasty mass is a thermoplastic mass which becomes pasty when heated and which hardens when it cools, or the pasty mass is a UV-curing mass.

10. The method according to claim 1, wherein the pasty mass forms a form-fitting connection with the workpiece following the hardening thereof.

11. The method according to claim 1, wherein the pasty mass is introduced into a side region of the opening.

12. The method according to claim 1, wherein when viewed from above, the opening is made in the workpiece in a linear manner.

13. The method according to claim 12, wherein the linear opening surrounds a workpiece region which is removed following the hardening of the pasty mass in the opening.

14. The method according to claim 1, wherein the method is carried out by a machining device, and wherein the workpiece is held in a single clamping operation.

15. A furniture element having a core layer, a first cover layer and a second cover layer, wherein a reinforcement section is introduced in layers through one of the cover layers and into the core layer.
